(19) United States
(12) Patent Application Publication
(10) Pub. No.: US 2016/0379755 A1
(43) Pub. Date: Dec. 29, 2016

(54) MANUFACTURING METHOD FOR MAGNET AND MAGNET

(71) Applicant: JTEKT CORPORATION, Osaka (JP)

(72) Inventors: Takumi MIO, Kariya-shi (JP); Koji NISHI, Anjo-shi (JP); Yusuke KIMOTO, Kariya-shi (JP); Takashi TAMURA, Itami-shi (JP)

(73) Assignee: JTEKT CORPORATION, Osaka (JP)

(21) Appl. No.: 15/185,352

(22) Filed: Jun. 17, 2016

(30) Foreign Application Priority Data
Jun. 24, 2015 (JP) 2015-126531
Jul. 3, 2015 (JP) 2015-134251
Jul. 3, 2015 (JP) 2015-134252
Jul. 7, 2015 (JP) 2015-135757

(51) Int. Cl. H01F 41/02; B22F 3/24; B22F 3/02; H01F 1/053; B22F 1/00

(52) U.S. Cl. CPC H01F 41/0266; H01F 1/0533; B22F 1/007; B22F 3/02; B22F 3/24; B22F 2301/355; B22F 2302/45; B22F 2998/10; B22F 2003/023; B22F 2003/248

(57) ABSTRACT

A manufacturing method for a magnet includes: a step of obtaining mixed powder of magnetic powder and a lubricant; a step of mixing the mixed powder with an uncured binder that is a silicone composition to attach the binder to a surface of the mixed powder; a step of molding the mixed powder under pressure to obtain a molding, and a step of curing the silicone composition to bind particles of the magnetic powder together,

### INCORPORATION BY REFERENCE

The disclosures of Japanese Patent Applications No. 2015-126531, No. 2015-135757, No. 2015-134251, and No. 2015-134252 respectively filed on Jun. 24, 2015, Jul. 7, 2015, Jul. 3, 2015, and Jul. 3, 2015 each including the specification, drawings and abstract, are incorporated herein by reference in their entireties.

### BACKGROUND OF THE INVENTION

1. Field of the Invention

The invention relates to a manufacturing method for a magnet and a magnet.

2. Description of the Related Art

Japanese Patent Application Publication No. 2003-318012 (JP 2003-318012 A) describes a permanent magnet (bonded magnet) containing magnetic powder for magnetic field orientation and a synthetic resin. JP 2003-318012 A discloses that the magnetic powder contains samarium-iron-nitrogen as main components. JP 2003-318012 A discloses that the synthetic resin is at least one synthetic resin selected from the group consisting of a polyamide resin, acrylonitrile-butadiene-styrene (ABS) resin, a polyvinyl chloride resin, a polyphenylene sulfide (PPS) resin, and chlorinated polyethylene resin.

In the bonded magnet described in JP 2003-318012 A, particles of the magnetic powder are bound together such that the synthetic resin contains the magnetic powder. When the volume of the magnetic powder is defined to be 100 vol %, normal bonded magnets contain 40 vol % or more synthetic resin. Magnetic characteristics of the bonded magnet are determined by the rate of magnetic powder contained in the bonded magnet (the content of the magnetic powder). A reduced content of the magnetic powder degrades the magnetic characteristics of the bonded magnet. An increased content of the magnetic powder not only degrades moldability of the magnet (moldability in injection molding) but also causes magnetic powder particles to be insufficiently fixed together, precluding the shape of the bonded magnet from being maintained. Therefore, for the bonded magnets, improvement of the magnetic characteristics (suppression of a decrease in residual magnetic flux density) is limited.

### SUMMARY OF THE INVENTION

An object of the invention is to provide a manufacturing method for a magnet and a magnet that allow a high residual magnetic flux density to be achieved.

According to an aspect of the invention, a manufacturing method for a magnet includes:
obtaining mixed powder of magnetic powder and a lubricant;
mixing the mixed powder with an uncured binder containing a silicone composition to attach the binder to a surface of the mixed powder;
molding the mixed powder under pressure to obtain a molding; and
curing the silicone composition to bind particles of the magnetic powder together.

In the manufacturing method for a magnetic according to the aspect, the uncured binder is attached to the surface of the mixed powder of the magnetic powder and the lubricant. Subsequently, the mixed powder is molded under pressure to obtain a molding. When the mixed powder is molded under pressure, the lubricant and the binder present between the particles of the magnetic powder in the mixed powder exhibit lubricity. The lubricity promotes movement of particles of the magnetic powder, allowing the particles to be rearranged. Moldability in formation of a molding is enhanced, providing a dense molding. The dense molding allows a dense magnet to be manufactured. Therefore, according to the manufacturing method in the invention, a magnet with a high residual magnetic flux density can be manufactured.

According to another aspect of the invention, a magnet is manufactured by the manufacturing method for a magnet as described in the above-described aspect.

The magnet according to the aspect has a high residual magnetic flux density.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a chart illustrating steps of a manufacturing method for a magnet in an embodiment;

FIG. 2 is a schematic diagram illustrating a step of mixing magnetic powder and a lubricant in the embodiment;

FIG. 3 is a schematic diagram illustrating the step of mixing the magnetic powder and the lubricant in the embodiment;

FIG. 4 is a sectional view schematically illustrating that the magnetic powder and a binder have been mixed together in the embodiment;

FIG. 5 is a schematic diagram illustrating a step of pressurizing the magnetic powder in the embodiment;

FIG. 6 is a schematic diagram illustrating the step of pressurizing the magnetic powder in the embodiment;

FIG. 7 is an enlarged view schematically illustrating an arrangement of the magnetic powder in a molding in the embodiment; and

FIG. 8 is an enlarged view schematically illustrating a configuration of the magnet in the embodiment.

### DETAILED DESCRIPTION OF EMBODIMENTS

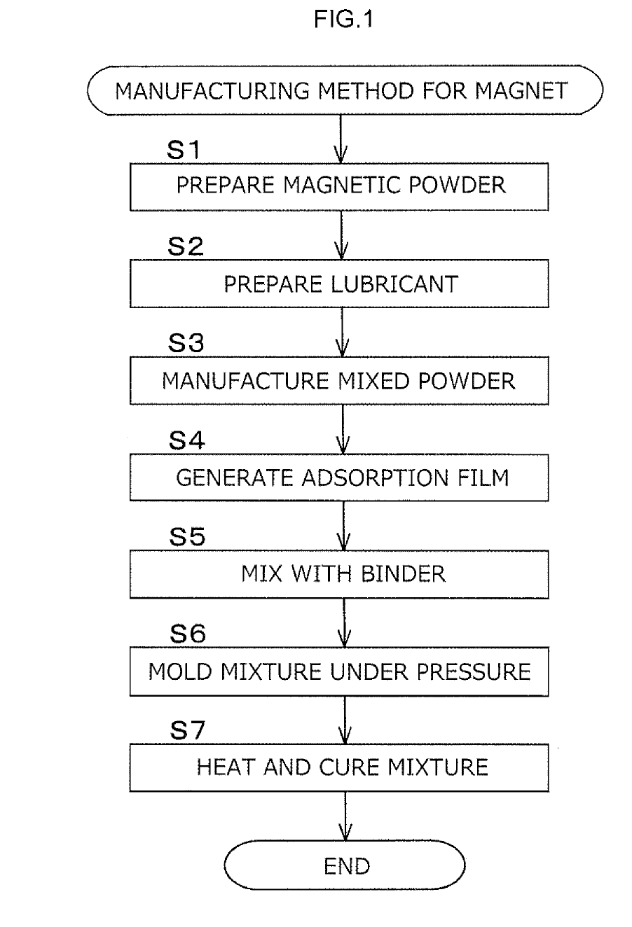

A manufacturing method for a magnet in the invention will be specifically described as an embodiment with reference to FIGS. 1 to 8. FIG. 1 is a chart illustrating steps of the manufacturing method for a magnet in the present embodiment.

As illustrated in step S1 in FIG. 1, magnetic powder 1 is prepared as a material for a magnet.

The magnetic powder 1 is powder that is an aggregate of particles of a magnetic material. The magnetic material for the magnetic powder 1 is not limited but is preferably a hard magnetic substance. Examples of the hard magnetic substance include a ferrite magnet, an Al—Ni—Co-based magnet, a rare earth magnet containing rare earth elements, and an iron nitride magnet.

As the magnetic powder 1 for the hard magnetic substance, a compound containing one or more of Fe—N-based compounds and R—Fe—N-based compounds (R: rare earth elements) is preferably used. The rare earth elements represented as R may be elements known as what is called rare earth elements (Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, and Lr) and are preferably rare earth elements other than Dy (R: rare earth elements other than Dy). Among these rare earth elements, light rare earth elements are particularly preferable. Among the light rare earth elements, Sm is most suitable. The light rare earth elements as used herein are elements included in lanthanoids and having a smaller atomic weight than Gd, that is, La to Eu. The Fe—N-based compound is contained in an iron nitride magnet. The R—Fe—N-based compound is contained in a rare earth magnet.

A specific composition of the magnetic powder 1 is not limited as long as the magnetic powder 1 contains the Fe—N-based compound or the R—Fe—N-based compound. The magnetic powder 1 is most preferably powder of Sm₂Fe₁₇N₃ or Fe₁₆N₂.

The particle size (average particle size) of the magnetic powder 1 is not limited. The average particle size (D50) is preferably approximately 2 to 5 μm. In the magnetic powder 1 used, an oxide film is not formed all over the surfaces of particles.

As illustrated in step S2 in FIG. 1, a lubricant 2 is prepared. The lubricant 2 is a substance that is solid (solid lubricant) under normal conditions (in an air atmosphere and at room temperature). As the lubricant 2, a powdery lubricant is used.

As the lubricant 2, a metal soap-based lubricant (solid lubricant powder) is used. The lubricant 2 is, for example, powder of stearic acid-based metal such as zinc stearate. The powder of the lubricant 2 has an average particle size (D50) of approximately 10 μm. The lubricant 2 preferably has a larger average particle size than the magnetic powder 1. The lubricant 2 has a smaller specific gravity than the magnetic powder 1. When the size of the lubricant 2 is increased to some degree in an initial state, each particle of the lubricant 2 may have an increased mass, allowing the lubricant 2 to be precluded from scattering around during mixture in step S3 described below.

A mixing ratio between the magnetic powder 1 and the lubricant 2 may be optionally set. For the mixing ratio between the magnetic powder 1 and the lubricant 2, preferably, the mixed powder contains 80 to 90 vol % magnetic powder 1 and 5 to 15 vol % lubricant 2. Besides the magnetic powder 1 and the lubricant 2, an additive may be contained. Examples of the additive include organic solvents that may be lost by subsequent heating.

As illustrated in step S3 in FIG. 1, the magnetic powder 1 and the lubricant 2 prepared in the above-described two steps are mixed together into mixed powder.

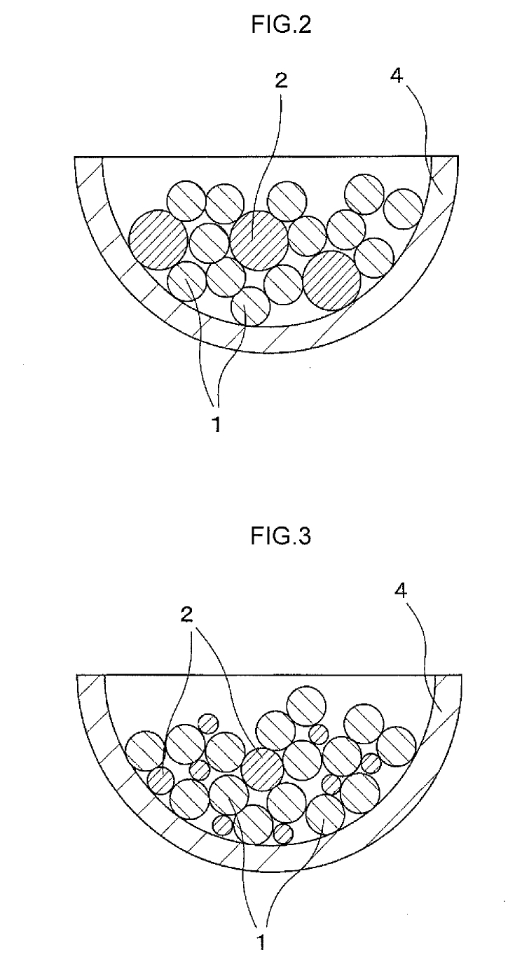

The magnetic powder 1 and the lubricant 2 are mixed together while being ground. A method for forming the mixed powder involves mixing the magnetic powder 1 and the lubricant 2 together while grinding the magnetic powder 1 and the lubricant 2 in a mixing container 4, as depicted in FIG. 2. When the magnetic powder 1 and the lubricant 2 are mixed together while being ground, the lubricant 2, which has a low binding strength, is fractionized to reduce the particle size of the lubricant 2 as a whole, as depicted in FIG. 3. At the end of step S3, particles of the lubricant 2 with different sizes are present.

Formation of the mixed powder 1 and 2 allows massive portions containing only the magnetic powder 1 to be reduced (allows secondary particles of the magnetic powder 1 to be crushed), and enables a reduction in the size of the lubricant 2. In other words, particles of the lubricant 2 resulting from fractionization can be placed in proximity to the individual particles of the magnetic powder 1.

Subsequently, as illustrated in step S4 in FIG. 1, the mixed powder 1 and 2 is heated to form an adsorption film 3 on the surface of the magnetic powder 1.

The mixed powder 1 and 2 resulting from mixing of magnetic powder 1 and the lubricant 2 in the above-described step (step S3) is heated at a heating temperature T1 to form the adsorption film 3 of the lubricant 2 on the surface of the magnetic powder 1. At this time, the heating temperature T1 for the mixed powder 1 and 2 is lower than a decomposition temperature T2 of the magnetic powder 1 and is equal to or higher than a melting point T3 of the lubricant 2 (T3≦T1<T2),

Heating the mixed powder 1 and 2 at the heating temperature T1 causes the lubricant 2 to be melted without decomposition of the magnetic powder 1. The melted lubricant 2 flows along the surfaces of the particles of the magnetic powder 1 to coat the surface of the magnetic powder 1. The adsorption film 3 is thus formed (generated) on the surface of the magnetic powder 1. Subsequently, the mixed powder 1 and 2 is cooled at a temperature lower than the melting point T3 to solidify the adsorption film 3.

A heating time t at the heating temperature T1 depends on the amount of heat applied to the mixed powder 1 and 2 and is not limited. In other words, the amount of heat applied to the mixed powder 1 and 2 per unit time increases consistently with heating temperature T1, enabling a reduction in the heating time t. When the heating temperature T1 is relatively low, the heating time t is preferably extended.

In connection with the heating temperature T1 and the heating time t, as the amount of heat applied to the mixed powder 1 and 2 increases, the adsorption film 3 is more aggregately generated on the surface of the magnetic powder 1. This prevents the film from being cut off during a pressurizing step (step S6). A dense molding 6 and a dense magnet 8 can be manufactured.

Subsequently, as illustrated in step S5 in FIG. 1, an uncured binder 5 is placed on the surface of the magnetic powder 1 with the adsorption film 3 formed thereon.

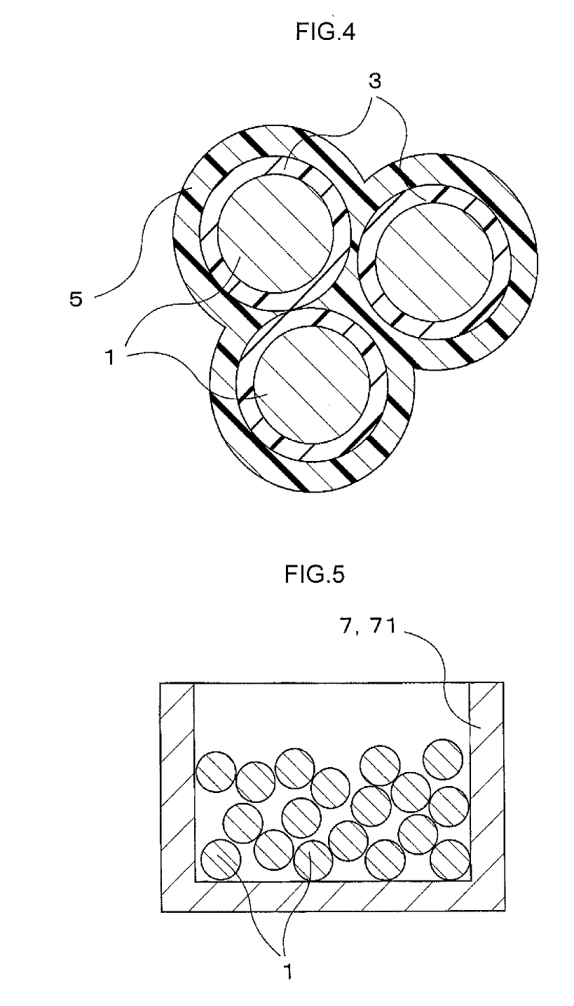

As the binder 5, an uncured binder containing a silicone composition is used. The binder 5 is gelled or liquid at room temperature and is fluid. Mixing the magnetic powder 1 with the binder 5 allows the binder 5 to be placed on the surfaces of the particles of the magnetic powder 1. In this state, as depicted in a schematic sectional view in FIG. 4, the binder 5 is interposed between the adjacent particles of the magnetic powder 1.

The silicone composition in the binder 5 is a composition having a main framework based on siloxane bonding. The silicone composition is, for example, a silicone resin. The silicone composition is uncured (gelled or liquid) when placed on the surface of the magnetic powder I and is cured during the subsequent step (in the present embodiment, during thermal curing in step S7).

A method for curing the binder 5 is not limited. The method involves, for example, heating the binder 5, irradiating the binder 5 with ultraviolet rays, or bringing the binder 5 into contact with a reaction initiator such as water to start curing. The present embodiment uses a thermosetting silicone composition that is cured by heating. Compared to radiated ultraviolet rays, heat is easily transmitted to the interior of the molding 6 to allow curing to be reliably achieved.

The thermosetting silicone composition has a curing temperature (curing start temperature) T4 that is lower than the decomposition temperature T2 of the magnetic powder 1.

The mixture rate of the binder 5 may be optionally set. For example, when the volume of the magnetic powder 1 (with the adsorption film 3 formed thereon) is defined to be 100 vol %, the mixed powder preferably contains 5 to 15 vol % binder 5 and more preferably 8 to 12 vol % binder 5.

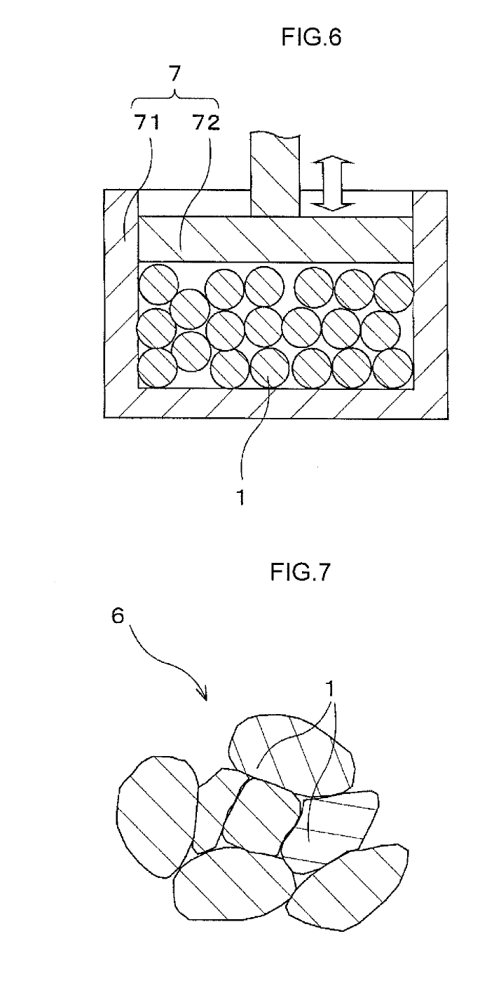

Subsequently, as illustrated in step S6 in FIG. 1, the magnetic powder 1 is pressurized to form a molding 6 (FIG. 5 and FIG. 6). In the magnetic powder 1 pressurized in the present step, the binder 5 is interposed between the particles.

In the pressurizing step, as schematically illustrated in FIG. 5, the magnetic powder 1 is placed in a cavity in a pressurizing mold 7 (pressurizing lower mold 71). The pressurizing mold 7 is formed of nonmagnetic steel. Pressurization of the pressurizing mold 7 is performed under the condition that lines of magnetic force are transmitted through the magnetic powder 1 (under the condition for magnetic field orientation).

Subsequently, as illustrated in a schematic diagram in FIG. 6, the magnetic powder 1 is molded under pressure by assembling a pressurizing upper mold 72 on the pressurizing lower mold 71 and moving the pressurizing lower mold 71 and the pressurizing upper mold 72 in a direction in which the molds approach each other. At this time, a pressure applied by the pressurizing mold 7 (71 and 72) is equal to or lower than a burst pressure at which the magnetic powder 1 is destroyed. In the present embodiment, the pressure is 1 GPa or lower.

Pressurization using the pressurizing mold 7 (71 and 72) is performed a plurality of times. After the pressure is applied to the pressurizing upper mold 72, the pressure applied to the pressurizing upper mold 72 is released and then, a pressure is applied to the pressurizing upper mold 72 again. This operation is repeated. To release the pressure applied to the pressurizing upper mold 72, the pressurizing upper mold 72 may be moved upward or the pressure applied to the pressurizing upper mold 72 may only be reduced without upward movement of the pressurizing upper mold 72.

The number of pressurizing operations using the pressurizing mold 7 (71 and 72) may be equal to the number of pressurizing operations resulting in saturation of the effect of an increase in the density of the molding 6. For example, the number of pressurizing operations may be 2 to 30.

Moreover, during the pressurizing step, the magnetic powder 1 in the pressurizing mold 7 (71 and 72) may be heated by heating the pressurizing mold 7 (71 and 72), for example, from an outer side surface thereof using a heater (not depicted in the drawings). At this time, a heating temperature T5 for the magnetic powder 1 is a temperature at which the adsorption film 3 is melted and liquefied (a temperature equal to or higher than the melting point T3) and which is lower than the curing temperature T4 of the binder 5. The heating temperature T5 is also lower than the decomposition temperature T2 of the magnetic powder 1 (T3<T5<T4<T2). Therefore, even with heating, the magnetic powder 1 is not decomposed and the binder 5 is also not cured.

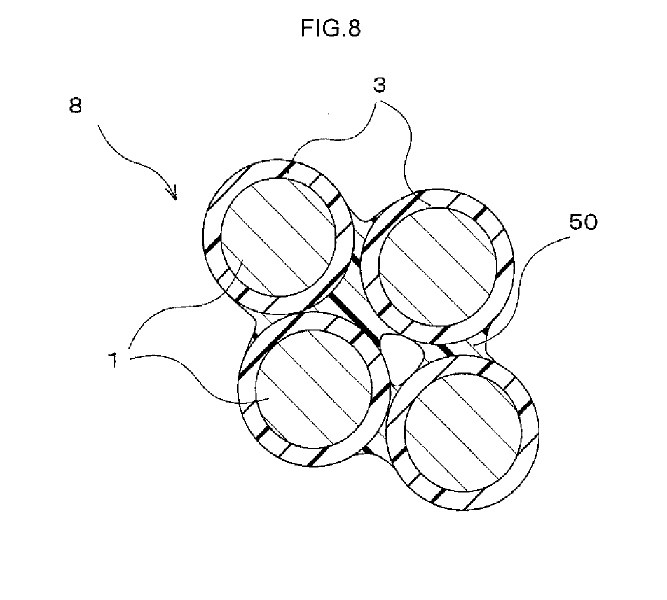

Repeated pressurizing operations using the pressurizing mold 7 allow formation of a molding 6 with reduced clearances between the particles of the magnetic powder 1 as illustrated in the enlarged view in FIG. 7. This is because a plurality of pressurizing operations rearranges the particles of the magnetic powder 1 from the arrangement of the particles of the magnetic powder 1 during the last pressurizing operation.

During the rearrangement of the particles of the magnetic powder 1, the particles of the magnetic powder 1 move very smoothly because the adsorption film 3 of the lubricant 2 is interposed between contact surfaces (sliding contact surfaces) of the adjacent particles of the magnetic powder 1. The clearances between the particles of the magnetic powder 1 in the molding 6 are reduced by a synergistic effect of the rearrangement of the particles of the magnetic powder 1 and sliding attributed to the adsorption film 3.

The uncured binder 5 is also interposed between the particles of the magnetic powder 1. The uncured binder 5 exhibits the characteristics of silicone oil and lubricity. In other words, movement (rearrangement) of the particles of of the magnetic powder 1 is promoted by the interposition of the adsorption film 3 and the uncured binder 5 between the adjacent particles of the magnetic powder 1. This action also serves to reduce the clearances between the particles of the magnetic powder 1 in the molding 6. That is, a molding 6 is obtained which has reduced clearances between the particles of the magnetic powder 1.

Subsequently, as illustrated in step S7 in FIG. 1, the molding 6 is heated to cure the binder 5.

A heating temperature T6 for the molding 6 is equal to or higher than the curing temperature (curing start temperature) T4 of the thermosetting silicone composition and is lower than the decomposition temperature T2 of the magnetic powder 1 (T4≦T6<T2).

The heating in the present step is performed by heating the molding 6 at the heating temperature T6. For example, the heating can be performed by setting the temperature of the pressurizing mold 7 equal to the heating temperature T6 without extracting, from the pressurizing mold 7, the molding 6 obtained using the pressurizing mold 7 in the above-described pressurizing step (step S6).

Alternatively, the molding 6 may be extracted from the pressurizing mold 7 and placed in a microwave heating furnace, an electric furnace, a plasma heating furnace, an induction hardening furnace, a heating furnace using an infrared heater, or the like.

The heating at the heating temperature T6 lasts until curing of the binder 5 is completed.

The magnet 8 in the present embodiment is manufactured through the above steps.

In the magnet 8 in the present embodiment that is manufactured by the above-described manufacturing method, as the configuration of the magnet 8 is illustrated in a schematic diagram in FIG. 8, a cured binder 50 binds the particles of the magnetic powder 1 together. The particles of the magnetic powder 1 do not join directly to other particles.

The binder 50 is interposed only near the contact portions of the particles of the magnetic powder 1. That is, the surfaces of the particles of the magnetic powder 1 are partly exposed. Minute voids may remain between the particles. In this case, the adsorption film 3 is formed on the surface of the magnetic powder 1, restraining the magnetic material from being exposed. In other words, the magnetic characteristics of the magnetic powder 1 are restrained from being degraded by, for example, oxidation resulting from the atmosphere.

In the manufacturing method in the present embodiment, the mixed powder 1 and 2 of the magnetic powder 1 and the lubricant 2 is used to generate the adsorption film 3 on the surface of the magnetic powder 1, and the uncured binder 5 is attached to the surfaces of the particles. Subsequently, the magnetic powder 1 is molded under pressure to obtain the molding 6. In this configuration, when the magnetic powder 1 is molded under pressure, the adsorption film 3 and the binder 5 between the particles of the magnetic powder 1 exhibit lubricity. The lubricity promotes movement of the particles of the magnetic powder 1 to rearrange the particles. In other words, the present embodiment enhances moldability in formation of the molding 6, providing a dense molding 6. The dense molding 6 allows a dense magnet 8 to be manufactured. Therefore, according to the manufacturing method in the present embodiment, the magnet 8 with a high residual magnetic flux density can be manufactured.

In the manufacturing method in the present embodiment, the metal soap-based lubricant (stearic acid-based metal) is used as the lubricant 2, and the mixed powder is heated at the temperature T1 equal to or higher than the melting point T3 of the lubricant 2 to melt the lubricant 2 and attach the melted lubricant 2 to the surface of the magnetic powder 1. Subsequently, the temperature of the mixed powder is lowered to a temperature lower than the melting point T3 so that the lubricant 2 is solidified to generate the adsorption film 3. The adsorption film 3 is adsorbed to the particles of the magnetic powder 1 and restrained from being peeled off (the lubricity is restrained from being degraded) even when the particles of the magnetic powder 1 slide during the pressurizing step. Movement of the particles of the magnetic powder 1 (rearrangement of the particles) is promoted to reliably provide the molding 6 with reduced clearances between the particles.

Furthermore, since the temperature of the metal soap-based lubricant 2 (stearic acid-based metal) is in temperature range where the metal soap-based lubricant 2 remains solid, the metal soap-based lubricant 2 does not mix with the binder 5 (silicone resin composition). Thus, even when the magnetic powder 1 is mixed with the lubricant 2 (adsorption film 3) and the binder 5 immediately before formation of the molding 6, both the lubricant 2 and the binder 5 can fully deliver their performances. This indicates that the present embodiment prevents degradation of the effect of the lubricity, which promotes rearrangement of the particles during pressurization, but also degradation of the bindability of the binder 5 (silicone resin composition).

In the manufacturing method in the present embodiment, as the magnetic powder 1 of the hard magnetic substance, a compound is used which is one or more of Fe—N-based compounds and R—Fe—N-based compounds (R: rare earth elements). This configuration allows the magnet to be inexpensively manufactured. Moreover, the manufacturing method in the present embodiment does not require using dysprosium (Dy) as R. That is, the magnet can be inexpensively manufactured.

In the manufacturing method in the present embodiment, the silicone composition is a thermosetting silicone composition, and the molding 6 is heated and cured. This configuration allows the particles of the magnetic powder 1 to be easily bound together. The heating can increase the temperature of even the interior of the molding 6, and thus even the interior of the molding 6 can be reliably cured. That is, a possible variation in the outside shape of the molding 6 (a possible decrease in dimensional accuracy) can be suppressed.

In the manufacturing method in the present embodiment, the curing temperature of the silicone composition is lower than the decomposition temperature of the magnetic powder. This configuration suppresses decomposition of the magnetic powder 1 even when the mixed powder is heated in order to cure the binder 5 (silicone composition). In other words, the binder 5 can be cured without degradation of the magnetic characteristics of the magnetic powder 1. Therefore, the magnet 8 can be manufactured for which the residual magnetic flux density is restrained from being reduced.

The magnet 8 in the present embodiment is manufactured by the above-described manufacturing method. This configuration provides a magnet that can produce all of the above-described effects.

The magnet 8 in the present embodiment has particles of the magnetic powder 1 and the cured binder 50 that binds the particles together. In this configuration, the binder 50 binds the particles of the magnetic powder 1 together and does not serve to shape the magnet 8. This enables a reduction in the content of the cured binder 50 (uncured binder 5). As a result, in the magnet 8, the volume of the binder 50 which delivers no magnetic performance, can be reduced, so that the magnet 8 has an excellent residual magnetic flux density.

In particular, the magnet 8 in the present embodiment allows the mixture rate of the binder 5 to be reduced to 5 to 15 vol %. This configuration indicates that the magnet 8 in the present embodiment is configured substantially equivalently to a green compact with the particles of the magnetic powder 1 bound together only at contact points thereof.

In contrast, the conventional bonded magnet contains 40 vol % or more synthetic resin. In other words, in the magnet 8 in the present embodiment, the content of the magnetic powder 1 can be increased by as much as 25 vol % or more compared to the conventional bonded magnet. The magnet 8 in the present embodiment thus has a high residual magnetic flux density.

Specifically, when the residual magnetic flux density of the conventional bonded magnet in which the mixture rate of the synthetic resin is 40 vol % is defined to be 100%, the residual magnetic flux density of the magnet 8 in the present embodiment in which the mixture rate of the binder 5 is 10 vol % is approximately 150%.

This indicates that the volume of the magnet 8 in the present embodiment is 66.7% of the volume of the conventional bonded magnet when both magnets contain the same amount (same volume) of magnetic powder 1. In other words, the volume of the magnet 8 in the present embodiment may be as much as 33.3% less than the volume of the conventional bonded magnet when both magnets have the same residual magnetic flux density.

What is claimed is:

1. A manufacturing method for a magnet comprising:
obtaining mixed powder of magnetic powder and a lubricant;
mixing the mixed powder with an uncured binder containing a silicone composition to attach the binder to a surface of the mixed powder;
molding the mixed powder under pressure to obtain a molding; and
curing the silicone composition to bind particles of the magnetic powder together.

2. The manufacturing method for a magnet according to claim 1, wherein
the lubricant is a metal soap-based lubricant, and
the mixed powder is heated to a temperature equal to or higher than a melting point of the lubricant to attach the lubricant to a surface of the magnetic powder, and the temperature of the mixed powder is lowered to a temperature lower than the melting point to solidify the lubricant.

3. The manufacturing method for a magnet according to claim 1, wherein
the magnetic powder is one or more of Fe—N-based compounds and R—Fe—N-based compounds (R: rare earth elements).

4. The manufacturing method for a magnet according to claim 1, wherein
the silicone composition is a thermosetting silicone composition, and
the molding is heated to cure the silicone composition.

5. The manufacturing method for a magnet according to claim 4, wherein
a curing temperature of the silicone composition is lower than a decomposition temperature of the magnetic powder.

6. A magnet manufactured by the manufacturing method for a magnet as claimed in claim 1.
